(19) United States
(12) Patent Application Publication
(10) Pub. No.: US 2017/0079044 A1
(43) Pub. Date: Mar. 16, 2017

(54) COMMUNICATION RESOURCE ALLOCATION

(71) Applicant: QUALCOMM Incorporated, San Diego, CA (US)

(72) Inventors: Hao Zhu, Milpitas, CA (US); Srinivas Katar, Fremont, CA (US)

(21) Appl. No.: 14/850,266

(22) Filed: Sep. 10, 2015

(51) Int. Cl. H04W 72/04

(52) U.S. Cl. CPC H04W 72/0493

(57) ABSTRACT

A method for resource allocation includes determining, based on topology information, resource compatibility between a first basic service set (BSS) and a second BSS. The method also includes, in response to determining the first BSS and the second BSS are incompatible, assigning a first device the first BSS to a first group of devices and assigning a second device of the second BSS to a second group of devices. The method further includes allocating a communication resource between multiple groups of devices, the multiple groups including the first group and the second group.

### I. FIELD

The present disclosure is generally related to communication resource allocation.

### II. DESCRIPTION OF RELATED ART

In a densely deployed wireless fidelity (WiFi) system, many access points (APs) may be deployed in an area. If the WiFi system includes multiple overlapping basic service sets (OBSSs), performance of the WiFi system may be negatively impacted. To illustrate, devices included in the WiFi system may use a media access control (MAC) protocol, such as a carrier sense multiple access (CSMA) protocol, in which a device defers using a shared channel if the device detects the shared channel is being used by another device. If a particular device repeatedly defers use of the shared channel, system throughput and per-link fair bandwidth allocation (e.g., fairness) of the WiFi system may degrade. In some implementations, a WiFi system may be designed such that non-overlapping channels are allocated to OBSSs. However, when non-overlapping channels are used, bandwidth efficiency of the WiFi system may be reduced if one or more OBSSs are idle (e.g., not communicating data).

### III. SUMMARY

In a particular aspect, a device includes a receiver configured to receive first topology information corresponding to a first basic service set (BSS). The apparatus further includes a processor configured to determine, based on the first topology information, resource compatibility between the first BSS and a second BSS and, in response to determining the first BSS and the second BSS are incompatible, to assign a first device of the first BSS to a first group of devices and to assign a second device of the second BSS to a second group of devices. The processor is further configured to allocate a communication resource between multiple groups of devices, the multiple groups including the first group and the second group.

In another particular aspect, a method for resource allocation includes determining, based on topology information, resource compatibility between a first basic service set (BSS) and a second BSS. The method also includes, in response to determining the first BSS and the second BSS are incompatible, assigning a first device of the first BSS to a first group of devices and assigning a second device of the second BSS to a second group of devices. The method further includes allocating a communication resource between multiple groups of devices, the multiple groups including the first group and the second group.

In another particular aspect, a non-transitory computer readable medium comprises instructions that, when executed by a processor, cause the processor to determine, based on topology information, resource compatibility between a first basic service set (BSS) and a second BSS and, in response to determining the first BSS and the second BSS are incompatible, assign a first device of the first BSS to a first group of devices and assigning a second device of the second BSS to a second group of devices. The instructions further cause the processor to allocate a communication resource between multiple groups of devices, the multiple groups including the first group and the second group.

In another particular aspect, an apparatus includes means for assigning a first device of a first basic service set (BSS) to a first group of devices of multiple groups of devices and assigning a second device of a second BSS to a second group of devices of the multiple groups of devices in response to determining, based on first topology information corresponding to the first BSS, that the first BSS and the second BSS are incompatible. The apparatus further includes means for accessing a communication resource based on an assigned group of the multiple groups.

### IV. BRIEF DESCRIPTION OF THE DRAWINGS

FIG. 1 is a diagram of a particular illustrative example of a wireless system that supports resource allocation;

FIG. 2 is another diagram of the system of FIG. 1 that illustrates examples of resource allocation in a wireless system;

FIG. 3 is a flow diagram that illustrates a particular example of a method of grouping basic service sets (BSSs) to allocate a downlink channel of a wireless system;

FIG. 4 is a flow diagram that illustrates a particular example of a method of grouping basic service sets (BSSs) to allocate an uplink channel of a wireless system;

FIG. 5 is a flow diagram that illustrates a particular example of a method of grouping basic service sets (BSSs) to allocate a communication resource of a wireless system;

FIG. 6 is a diagram of a wireless device that is operable to support various aspects of one or more methods, systems, apparatuses, or computer-readable media disclosed herein.

### V. DETAILED DESCRIPTION

Particular aspects of the present disclosure are described below with reference to the drawings. In the description, common features are designated by common reference numbers throughout the drawings. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

In the present disclosure, a dynamic channel access control mechanism to enable adaptive channel reuse among multiple basic service sets (BSSs) is provided. To illustrate, a system may include multiple BSSs and at least two of the multiple BSSs may be overlapping BSSs (OBSSs). Each BSS may include an access point (AP) and one or more stations (STAs) associated with the AP. Each AP may collect topology information related to its corresponding BSS and may share its topology information with other APs. For example, the topology information may include positioning information (e.g., where STAs and APs are positioned with respect to each other or a fixed reference point), interference information (e.g., whether and how much communication by one STA or AP interferes with communication by another STA or another AP), or a combination thereof. The AP may collect the topology information by generating the topology information, by receiving the topology information from STAs associated with the AP, or a combination thereof. A device, such as an AP or a STA, may determine its positioning information using a global positioning system (GPS), triangulation, or another position acquisition technique, as illustrative, non-limiting examples. Additionally or alternatively, the device may determine interference information based on signal strength, transmit signal strength, signal-to-noise ratio, signal attenuation, or a combination thereof, as illustrative, non-limiting examples. The topology information may be used to determine compatibility between multiple BSSs, such as compatibility between STAs of different BSSs, as described herein.

A first AP of a first BSS may collect its own topology information and may receive second topology information from a neighboring AP, such as a second AP of a second BSS. The first AP may determine resource compatibility, such as a channel reuse capability, between the first BSS and the second BSS based on the topology information of the first AP and the second AP. The channel reuse capability may indicate whether two STAs can concurrently use the same communication resource, such as the same communication channel. For example, the first AP may determine whether a first link (between the first AP and a first STA of the first BSS) can tolerate interference caused by a second link (between the second AP and a second station of the second BSS), and vice versa. If two BSSs are compatible, each BSS can tolerate interference caused by the other BSS and the two BSSs can concurrently use a communication resource (e.g., the two BSSs can reuse a communication channel). Alternatively, if two BSSs are incompatible, at least one BSS cannot tolerate interference cause by the other BSS. As used herein, a “communication resource” may be defined as or include a communication channel (or a frequency band) that includes one or more “portions”, such as one or more sub-bands. Additionally, a “portion of a communication resource” may correspond to a “sub-band of a frequency band”.

If the first BSS and the second BSS are compatible, the first AP may assign a first device of the first BSS and a second device of the second BSS to the same group of devices of multiple groups of devices. In some implementations, each device of the first BSS and each device of the second BSS may be assigned to the same group. By being included in the same group of devices, the first device and the second device may simultaneously use the same portion of a communication resource, such as the same range of frequencies of a communication resource. Alternatively, if the two BSSs are incompatible, one of the two BSSs cannot tolerate interference caused by the other BSS and the BSS that cannot tolerate the interference may consistently defer to the other BSS with respect to accessing the communication resource. If the first BSS and the second BSS are incompatible, the first AP may assign the first device of the first BSS and the second device of the second BSS to different groups of devices of the multiple groups of devices. In some implementations, each device of the first BSS may be assigned to a first group of devices and each device of the second BSS may be assigned to a second group of devices. The different groups do not use the same sub-band of a communication channel (e.g., frequency band) at the same time. The communication channel (or sub-bands of the communication channel) may be allocated to each group of the multiple groups of devices in a frequency domain or in a time domain. For example, if the communication channel is allocated in the frequency domain, each group may be allocated a corresponding sub-band of the communication channel to use. As another example, if the communication channel is allocated in the time domain, each group may be allocated a corresponding time period to use an entirety of the communication channel.

In some implementations, a set of “strong” stations may be identified for one or more BSSs and may be grouped together in a particular group of devices (e.g., a strong group of devices) of the multiple groups of devices. A “strong” station may be a station that is determined to be sufficiently close to its associated AP. For example, an amount of interference received at the strong station from each STA or from an AP of a neighboring BSS may be less than a threshold. In some implementations, if the BSSs support bidirectional communication, such as downlink traffic and uplink traffic, a first set of multiple groups of devices may be generated for downlink traffic and a second set of multiple groups of devices may be generated for uplink traffic. Access to the communication resource may be allocated among the first set of multiple groups and among the second set of multiple groups.

By assigning STAs or BSSs to different groups of devices, the dynamic channel access control mechanism (included in the first AP) may allocate use of the communication resource, such as a communication channel, among the different groups of devices or BSSs. Devices of a particular group of devices (and excluding devices of other groups of devices) may access the communication resource based on the allocation of the communication resource to the particular group. Accordingly, devices of the particular group do not need to compete with or defer to devices of other groups of devices to access the communication resource, which may improve system throughput and fairness in a densely deployed WiFi system. Additionally, the dynamic channel access control mechanism may be implemented in conjunction with (e.g., without disruptive change to) WiFi hardware and media access control (MAC) protocols, such as a carrier sense multiple access (CSMA) protocol. For example, each device may use the WiFi hardware and the MAC protocols while accessing the communication resource according to the allocation of the communication resource. Accordingly, the dynamic channel access control mechanism may be implemented without additional hardware or without an additional protocol.

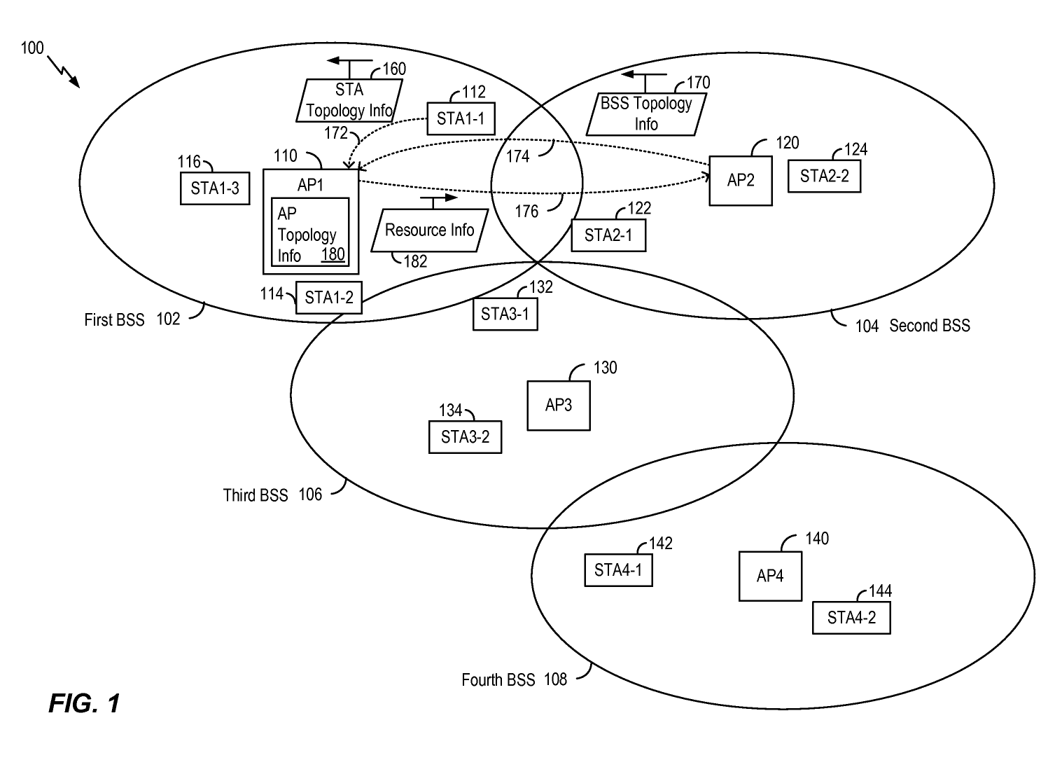

Referring to FIG. 1, a system that supports resource allocation is depicted and generally designated 100. The system 100 may include a wireless fidelity (WiFi) system. The system 100 may operate in accordance with one or more standards, such as an Institute of Electrical and Electronics Engineers (IEEE) 802.11 standard (e.g., a IEEE 802.11ac standard), as an illustrative, non-limiting example. In some implementations, one or more devices of the system 100 may communicate according to a media access control (MAC) protocol, such as a carrier sense multiple access (CSMA) protocol.

The system 100 may include multiple basic service sets (BSSs) 102-108. The multiple BSSs 102-108 may include a first BSS 102, a second BSS 104, a third BSS 106, and a fourth BSS 108. At least two of the multiple BSSs 102-108 included in the system 100 may be overlapping BSSs (OBSSs). For example, as depicted in FIG. 1, each BSS of the multiple BSSs 102-108 overlaps with at least one other BSS. Although the system 100 is described as including four BSSs, in other implementations, the system 100 may include more than or fewer than four BSSs.

Each of the multiple BSSs 102-108 may include a corresponding access point (AP). For example, the first BSS 102 may include a first AP (AP1) 110, the second BSS 104 may include a second AP (AP2) 120, the third BSS 106 may include a third AP (AP3) 130, and the fourth BSS 108 may include a fourth AP (AP4) 140. In some implementations, one or more of the APs 110, 120, 130, 140 may be a fixed device, while in other implementations, one or more of the APs 110, 120, 130, 140 may be a mobile communication device.

Each AP may be associated with one or more stations (STAs). For example, the first AP (AP1) 110 may be associated with a first station (STA1-1) 112, a second station (STA1-2) 114, and a third station (STA1-3) 116. The second AP (AP2) 120 may be associated with a fourth station (STA2-1) 122 and a fifth station (STA2-2) 124. The third AP (AP3) 130 may be associated with a sixth station (STA3-1) 132 and a seventh station (STA3-2) 134. The fourth AP (AP4) 140 may be associated with an eighth station (STA4-1) 142 and a ninth station (STA4-2) 144. In some implementations, one or more of the STAs 112-116, 122, 124, 132, 134, 142, 144 may be a fixed device, while in other implementations, one or more of the STAs 112-116, 122, 124, 132, 134, 142, 144 may be a mobile communication device.

As used herein, a link may refer to a communication path between a first device configured as a transmitter device and a second device configured as a receiver device. For example, a first link may correspond to a first communication path between the first AP 110 (configured as a transmitter device) and the first STA 112 (configured as a receiver device). As another example, a second link may correspond to a second communication path between the second AP 120 (configured as a transmitter device) and the fourth STA 122 (configured as a receiver device). Messaging from a transmitter device to a receiver device may correspond to data messaging and messaging from the receiver device to the transmitter device may correspond to acknowledge (ACK) messaging.

During operation, the first AP 110 may collect system topology information of the system 100. The system topology information may include position information or interference information corresponding to devices of the system 100. A device, such as an AP or a STA, may determine its positioning information using a global positioning system (GPS), triangulation, or another position acquisition technique, as illustrative, non-limiting examples. Additionally or alternatively, the device may determine interference information based on signal strength, transmit signal strength, signal-to-noise ratio, signal attenuation, or a combination thereof, as illustrative, non-limiting examples. As a non-limiting example, if the device receives or detects a signal having a relatively strong received signal strength indication (RSSI) from another device, the device may determine that sharing a sub-band with the other device may cause interference. As another example, if the device transmits a signal to another device, the device may receive an acknowledgement message from the other device indicating the RSSI of the signal received by the other device. To collect the system topology information of the system 100, the first AP 110 may receive station topology information from one or more STAs associated with the first AP 110, may generate AP topology information, or may receive BSS topology information (including station topology information or AP topology information of a particular BSS) from another AP of the system 100, as described herein.

For example, each STA of the system 100 may generate station topology information and may send the station topology information to its associated AP. The station topology information may include position information or interference information, such as attenuation information, corresponding to a particular station that generates the station topology information. To illustrate, the first STA 112 may generate station topology information 160 that the first STA 112 transmits to the first AP 110 as indicated by the dashed line 172. The station topology information 160 may include position information of the first STA 112 or interference information determined by the first STA 112. In some implementations, the interference information determined by the first STA 112 may include signal attenuation from the first AP 110 to the first STA 112 or signal attenuation from a neighboring AP, such as the second AP 120 or the third AP 130, to the first STA 112. For example, the first STA 112 may receive an indication from the first AP 110 of a transmit signal strength of a first message sent by the first AP 110 and the first STA 112 may determine a received signal strength of the first message. The first STA 112 may determine signal attenuation from the first AP 110 to the first STA 112 based on the transmit signal strength and the received signal strength of the first message. As another example, the first STA 112 may send a second message using a transmit signal strength and may receive an indication from the first AP 110 of a received signal strength of the second message. The first STA 112 may determine signal attenuation from the first STA 112 to the first AP 110 based on the transmit signal strength and the received signal strength of the second message.

Additionally or alternatively, the interference information determined by the first STA 112 may include an estimated signal attenuation from one or more stations to the first STA 112. For example, the one or more stations may include or correspond to stations associated with APs other than the first AP 110. The first STA 112 may determine the estimated signal attenuation from the one or more stations using a statistical technique, such as an average signal attenuation (e.g., a moving average signal attenuation), a peak signal attenuation, or a histogram, as illustrative, non-limiting examples. For example, the first STA 112 may monitor a total amount of interference received from one or more devices of the second BSS 104 during a time period. The first STA 112 may determine that the interference is from devices of the second BSS 104 based on device identifiers in data packets that cause the interference. The first STA 112 may determine an average amount of interference during the time period based on the total amount of interference.

In some implementations, the first STA 112 may determine a single estimated signal attenuation for all neighboring stations, such neighboring stations of multiple neighboring BSSs. In other implementations, the first STA 112 may determine an estimated signal attenuation of one or more neighboring stations for each neighboring AP (e.g., each neighboring BSS). For example, the first STA 112 may determine a first estimated signal attenuation of one or more stations of the second BSS 104 and may determine a second estimated signal attenuation of one or more stations of the third BSS 106.

In addition to one or more STAs determining station topology information, one or more APs of the system 100 may generate AP topology information. The AP topology information may include positon information or interference information corresponding to a particular AP that generates the AP topology information. To illustrate, the first AP 110 may generate AP topology information 180. The AP topology information 180 may include position information of the first AP 110 or interference information determined by the first AP 110. The interference information determined by the first AP 110 may include signal attenuation from each STA associated with the first AP 110 to the first AP 110, signal attenuation from each neighboring AP of the first AP 110 to the first AP 110. For example, the first AP 110 may receive the STA topology information 160 from the first STA 112. The STA topology information 160 may include a received signal strength of a first message received by the first STA 112 or a transmit signal strength of a second message transmitted by the first STA 112. If the first AP 110 transmitted the first message, the first AP 110 may use a transmit strength of the first message and the received signal strength of the first message to determine a signal attenuation from the first AP 110 to the first STA 112. If the first AP received the second message, the first AP 110 may use a received signal strength of the second message and the transmit signal strength of the second message to determine a signal attenuation from the first STA 112 to the first AP 110.

Additionally or alternatively, the interference information determined by the first AP 110 may include an estimated signal attenuation from one or more stations to the first AP 110. For example, the one or more stations may include or correspond to stations associated with APs other than the first AP 110. The first AP 110 may determine the estimated signal attenuation from the one or more stations using a statistical technique, such as an average signal attenuation (e.g., a moving average of signal attenuation), a peak signal attenuation, or a histogram of signal attenuations, as illustrative, non-limiting examples. In some implementations, the first AP 110 may determine a single estimated signal attenuation for all neighboring stations. In other implementations, the first AP 110 may determine an estimated signal attenuation of one or more neighboring stations for each neighboring AP (e.g., each neighboring BSS). For example, the first AP 110 may determine a first estimated signal attenuation of one or more stations of the second BSS 104 and may determine a second estimated signal attenuation of one or more stations of the third BSS 106.

The AP topology information 180 and the STA topology information from each STA of the first BSS 102 may be collectively referred to as BSS topology information of the first BSS 102. The BSS topology information of the first BSS 102 may be maintained (e.g., stored) at the first AP 110 or communicated from the first AP 110 to other APs of the system 100. Additionally, the first AP 110 may receive BSS topology information for one or more BSSs included in the system 100. BSS topology information of a particular BSS may include AP topology information of the AP of the particular BSS and STA topology information for each STA included in the BSS. For example, the first AP 110 may receive BSS topology information 170 from the second AP 120 as indicated by the dashed line 174. The BSS topology information 170 may include AP topology information generated by the second AP 120 and STA topology information generated by each of the fourth STA 122 and the fifth STA 124. Additionally or alternatively, the first AP 110 may receive BSS topology information from each of the third AP 130 and the fourth AP 140. For example, the fourth AP 140 may send BSS topology information of the fourth BSS 108 to the third AP 130 and the third AP 130 may forward the BSS topology information of the fourth BSS 108 to the first AP 110. The first AP 110 may maintain or receive BSS topology information for each BSS included in the system 100.

After collecting the system topology information, the first AP 110 may determine resource compatibility between different BSSs of the system 100. For example, the resource compatibility may correspond to whether two BSSs, such as two neighboring BSSs, can tolerate interference from each other if the two BSSs reuse the same communication channel, such as the same frequency band, at the same time. To determine if two BSSs, such as the first BSS 102 and the second BSS 104, can tolerate interference from each other, the first AP 110 may determine whether one or more links of the first BSS 102 are compatible with one or more links of the second BSS 104. A first link of the first BSS 102 may be compatible with a second link of the second BSS 104 if both links reuse a communication channel and have a first signal-to-interference-plus-noise ratio (SINR) greater than a first threshold (e.g., the first threshold equal to 20 decibel (dB)) for data messaging and have a second SINR caused by the other link that is greater than a second threshold (e.g., the second threshold equal to 10 decibel (dB)) for ACK messaging. To illustrate, for a data message communicated from a transmitter device of the first link to a receiver device of the first link:
SINR_{data}_{_}_{message}>(the first threshold); and,
   for an ACK message from the receiver device of the first link to the transmitter device of the first link:
SINR_{ACK}_{_}_{message}>(the second threshold).
   The first link and the second link may not be compatible if the first SINR of one of the first link or the second link is less than or equal to the first threshold or if the second SINR of one of the first link or the second link is less than or equal to the second threshold.

If two links are compatible, the first AP 110 may assign the two links (each link corresponding to a different station) to the same group of devices of multiple groups of devices. For example, if the first link of the first BSS 102 is determined to be compatible with the second link of the second BSS 104, each of the first link and the second link may be assigned to a first group of devices, such as a first group of devices. As used herein, if a particular BSS is assigned to a particular group of devices, each device (e.g., STA, AP, or both) included in the BSS may be assigned to the particular group of devices. Alternatively, if the two links are incompatible, the first AP 110 may assign the two links to different groups of devices of the multiple groups of devices. For example, if the first link of the first BSS 102 is determined to be incompatible with the second link of the second BSS 104, the first link (corresponding to a first device of the first BSS 102) may be assigned to the first group of devices and the second link (corresponding to a second device of the second BSS 104) may be assigned to a second group of devices. In some implementations, if two links of two different BSSs are determined to be incompatible, the first AP 110 may automatically determine that the two BSSs are also incompatible. The first AP 110 may generate group information that indicates which group(s) of devices that each device (e.g., AP, STA, or both) or each BSS are included in. The first AP 110 may periodically (or at other times based on resource availability of network usage) receive updated system topology information to determine whether links that were previously determined to be compatible have become incompatible. In this scenario, the links may be assigned to different groups of devices upon the determination of incompatibility.

In some implementations, the first AP 110 may determine resource compatibility between each link of a particular BSS and each link of each neighboring BSS. For example, the first AP 110 may determine resource compatibility between each link of the first BSS 102 and each link of the second BSS 104 and the third BSS 106. As another example, the first AP 110 may determine resource compatibility between each link of the second BSS 104 and each link of the first BSS 102 and the third BSS. As another example, the first AP 110 may determine resource compatibility between each link of the third BSS 106 and each link of the first BSS 102, the second BSS 104, and the fourth BSS 108. In other implementations, the first AP 110 may determine resource compatibility between each link of a particular BSS and each link of each BSS (other than the particular BSS) of the system 100. Additionally or alternatively, the first AP 110 may assign a particular device (or a particular BSS) to one or more groups of devices based on one or more resource compatibility determinations.

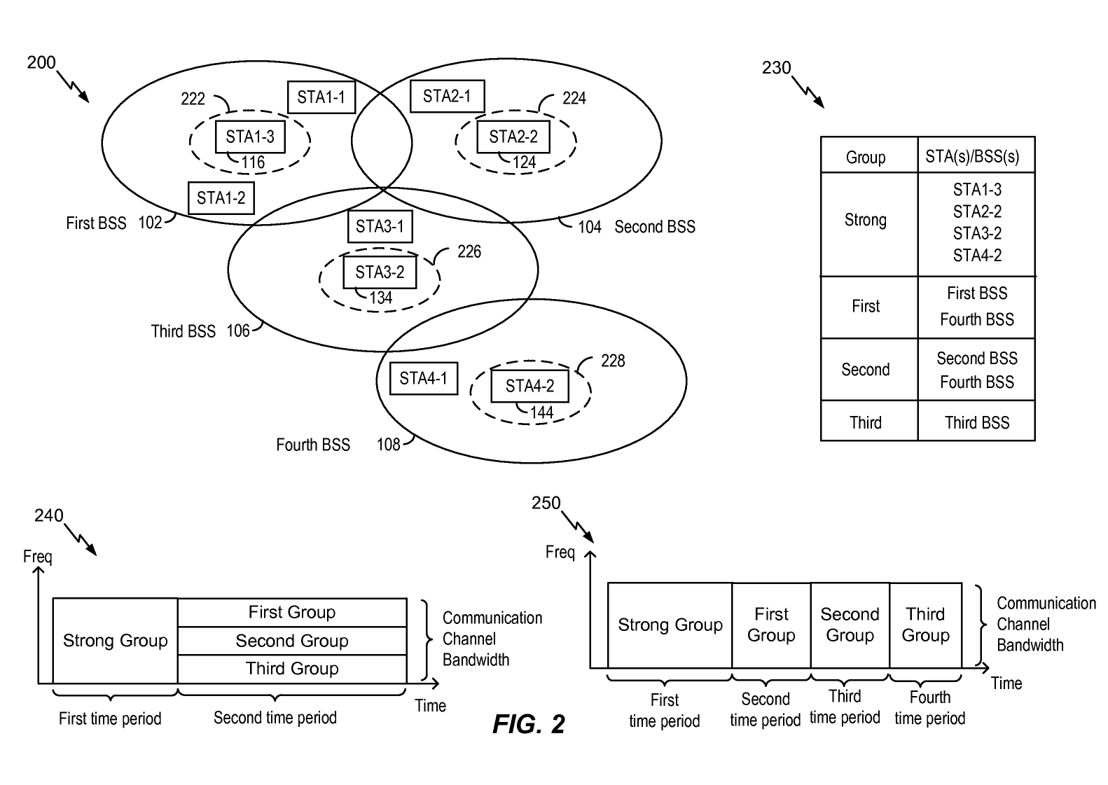

After assigning devices of the BSSs 102-108 into multiple groups of devices, the first AP 110 may allocate a communication resource, such as a communication channel, to these groups. The communication resource may be allocated in a frequency domain or in a time domain, as described with reference to FIG. 2. For example, allocating the communication resource may include allocating time periods to one or more groups of the multiple groups of devices, such as a first group of devices and a second group of devices. Allocating the time periods to the multiple groups may include indicating a corresponding time period when devices or BSSs of a group may access the communication channel. As another example, allocating the communication resource may include allocating one or more sub-bands of a frequency band (e.g., of the communication channel) to one or more groups of devices of the multiple groups of devices. Allocating the one or more sub-bands may include indicating a sub-band of the communication channel that devices or BSSs of a group may access. The first AP 110 may generate allocation data that indicates how the communication resource is allocated among the multiple groups. For example, the allocation data may indicate that a first group of devices has been allocated a first portion of the communication resource during a first time period and that a second group of devices has been allocated a second portion of the communication channel during a second time period. The first AP 110 may send resource information 182 that includes the group information and the allocation information to one or more APs of the system 100. For example, the first AP 110 may send the resource information 182 to the second AP 120 as indicated by dashed link 176. A particular AP that receives the resource information 182 may forward the resource information 182 to other APs of the system 100. Additionally, each AP that receives the resource information 182 may distribute the resource information 182 to one or more STAs associated with the AP. Each device (e.g., AP, STA, or both) or each BSS of the system 100 may use the communication resource as indicated by the resource information 182. To illustrate, if the first BSS 102 is assigned to the first group, the first STA 112 may access (e.g., use) a first sub-band of the communication channel during the first time period. As another example, if the second BSS is assigned to the second group, the fourth STA 122 may access the second portion of the communication resource during the second time period.

In some implementations, the first AP 110 may determine resource compatibility between two BSSs, such as the first BSS 102 and the second BSS 104, by determining resource compatibility between at least one link of the first BSS 102 and at least one link between of the second BSS 104. For example, the first AP 110 may identify, based on station topology information (e.g., positioning information or interference information), a particular STA of the first BSS 102 that is farthest away from the first AP 110 or that has a lowest received signal strength as measured by the first AP 110. If the first AP 110 determines that a link that includes the particular STA (i.e., the farthest STA or a STA having the lowest received signal strength) is compatible with one or more links of a neighboring BSS, such as the second BSS 104, then the first AP 110 may determine that the first BSS 102 is compatible with the second BSS 104. For example, if a link of the first BSS 102 that includes the first AP 110 and the particular STA, such as the farthest STA from the first AP 110, is determined to be able to tolerate interference (as determined based on the first threshold and the second threshold), then links that include STAs that are closer to the first AP 110 may also be assumed to be able to tolerate interference (as determined based on the first threshold and the second threshold).

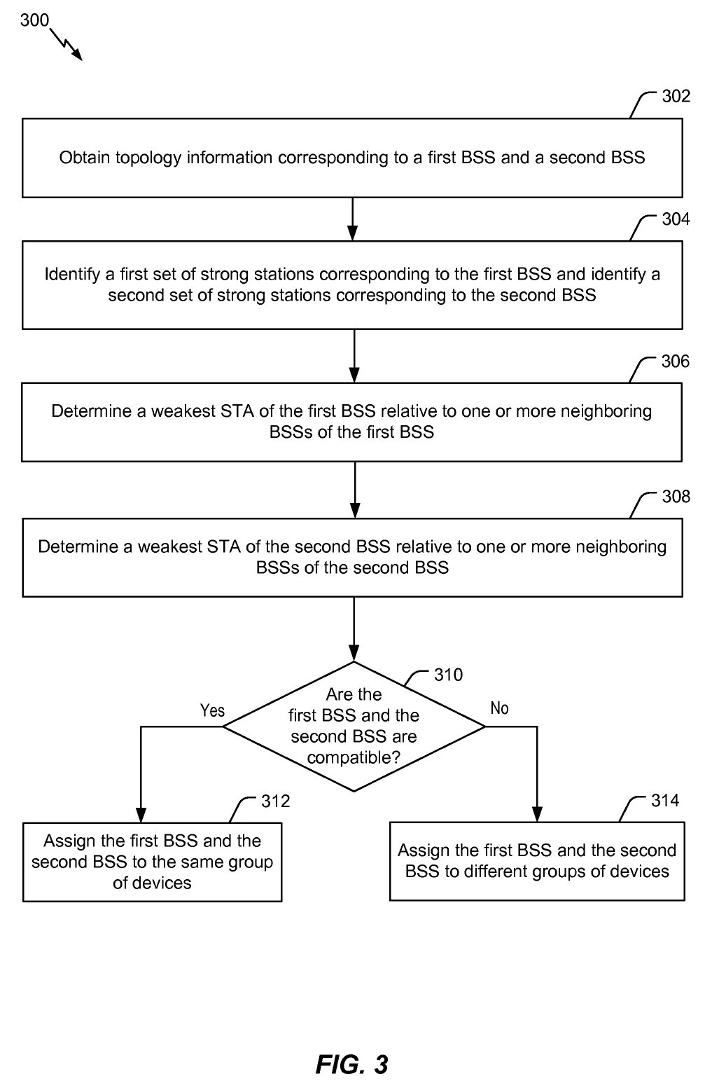

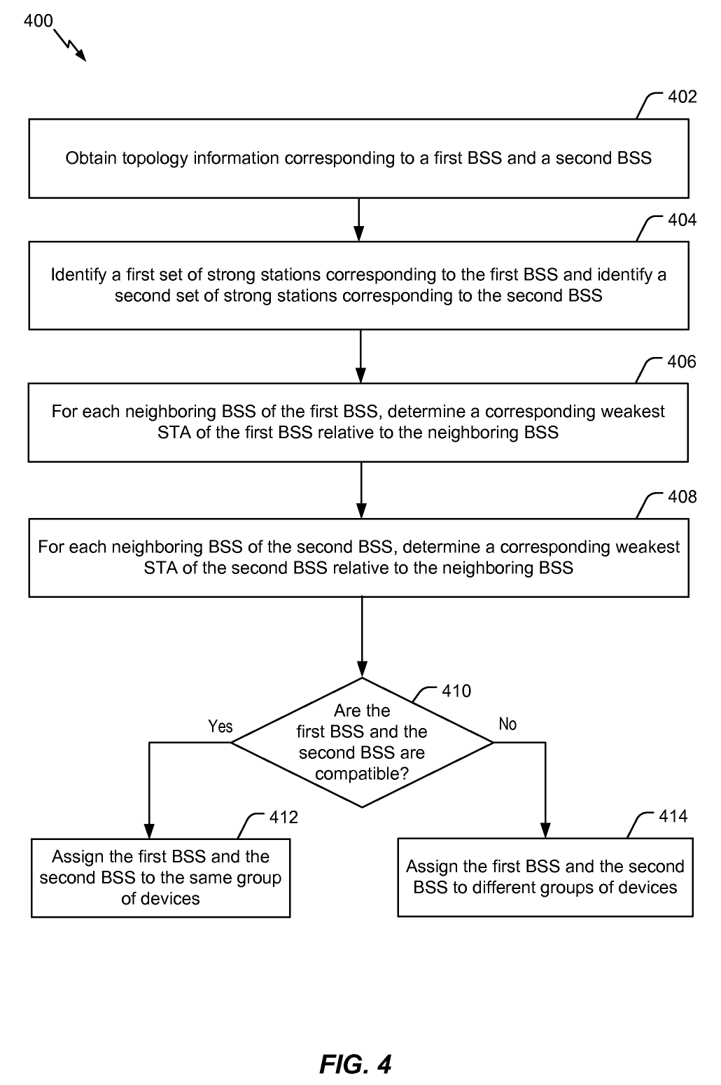

In some implementations, the first AP 110 may identify a STA that is a strong STA. A “strong STA” may include a STA that is in close physical proximity to an associated AP, has a high received signal strength as determined by the associated AP, or can tolerate interference (as determined based on the first threshold and the second threshold) from each neighboring BSS. Accordingly, strong STAs from different BSSs may reuse a communication channel (or reuse a sub-band of the communication channel) because each strong STA can tolerate interference from each neighboring BSS. The first AP 110 may identify one or more strong STAs of at least one BSS as described further with reference to FIGS. 3-4. In some implementations, the first AP 110 may assign each strong STA to the same group, such as a strong group of devices of the multiple groups of devices. The first AP 110 may allocate an entire bandwidth of a communication channel for a period of time to the strong group.

In some implementations, the communication resource may be used to communicate bidirectional traffic, such as uplink traffic and downlink traffic. Downlink traffic may correspond to data messages that are sent from an AP to an associated STA and uplink traffic may correspond to data messages that are sent from a STA to an associated AP. If the communication resource is a communication channel, access to the communication resource may be divided between the uplink traffic and the downlink traffic. If the communication resource can be used for bidirectional traffic, the first AP 110 may generate a first grouping of devices (e.g., APs, STAs, or both) for downlink traffic, as described with reference to FIG. 3. Additionally or alternatively, if the communication resource can be used for bidirectional traffic, the first AP 110 may generate a second grouping of devices (e.g., APs, STAs, or both) for uplink traffic, as described with reference to FIG. 4.

In some implementations, the first AP 110 may determine resource compatibility between devices of two BSSs, such as between a first device of the first BSS 102 and a second device of the second BSS, based on positioning information. For example, the first AP 110 may receive first position data, such as GPS data, of the first device, second position data of the second device, and third position data of the second AP 120. The first device and the second device may be compatible if a first distance between the first device of the first BSS 102 and the second AP 120 is greater than or equal to a first threshold distance and if a second distance between the second device of the second BSS 104 and the first AP 110 is greater than or equal to a second threshold distance. The first threshold distance and the second threshold distance may be the same or may be different. Additionally or alternatively, the first device and the second device may be compatible if a distance between the first device and the second device is greater than or equal to a third threshold distance.

Although certain operations or functions of the system 100 have been described with respect to a corresponding STA or AP, each of the APs 110, 120, 130, 140 or each of the STAs 112-116, 122, 124, 132, 134, 142, 144 may be configured to perform one or more operations or functions described with another of the APs 110, 120, 130, 140 or the STAs 112-116, 122, 124, 132, 134, 142, 144. For example, each STA may operate as described with reference to the first STA 112. Additionally or alternatively, each AP of the system 100 may operate as described with reference one or more of the APs 110, 120, 130, 140. Although one or more operations or function of the system 100 have been described with reference to the first AP 110, in other implementations, the operations or the functions may be performed by a different device, such as a device (not shown) that is coupled one or more devices of the system 100 via a wired network or a wireless network. As illustrative, non-limiting examples, the device may include a server or computer that is coupled to the first AP 110.

By assigning STAs (or BSSs) to different groups of devices, the first AP 110 may allocate use of the communication channel (or a sub-band of the communication channel) among multiple groups of devices. Devices of a particular group of devices (and not devices of other groups of devices) may access the communication resource based on the allocation of the communication resource to the particular group. Accordingly, devices of the particular group of devices do not need to compete with or defer to devices of the other groups of devices to access the communication resource, which may improve system throughput and fairness in the system 100, such as a densely deployed WiFi system. Additionally, allocation of the communication resource may be implemented in conjunction with (e.g., without disruptive change to) WiFi hardware and media access control (MAC) protocols, such as a carrier sense multiple access (CSMA) protocol. For examples, each device may use the WiFi hardware and the MAC protocols while accessing the communication resource according to the allocation of the communication resource. Accordingly, the allocation of the communication resource may be implemented without additional hardware or without an additional protocol.

FIG. 2 illustrates a system 200 that supports resource allocation. The system 200 may include or correspond to the system 100 of FIG. 1. As illustrated in FIG. 2, one or more devices, such as the APs 110, 120, 130, 140, of the system 100 have been omitted for ease of illustration.

The system 200 illustrates a set of strong STAs for each of the BSSs 102-108. For example, the first BSS 102 may include a first set of strong STAs 222 that includes the third STA (STA1-3) 116. The second BSS 104 may include a second set of strong STAs 224 that includes the fifth STA (STA2-2) 124, the third BSS 106 may include a third set of strong STAs 226 that includes the seventh STA (STA3-2) 134, and the fourth BSS 108 may include a fourth set of strong STAs 228 that includes the ninth STA (STA4-2) 144. Although each of the BSSs 102-108 is described as having a corresponding set of strong STAs, in other implementations, none of the BSSs 102-108 may have a corresponding set of strong STAs or at least one of the BSSs 102-108 may have a corresponding set of strong STAs.

An example of a table that includes group information is depicted and generally designated 230. The table 230 may be included in the resource information 182 of FIG. 1. The table 230 identifies multiple groups of devices, such as a strong group of devices, a first group of devices, a second group of devices, and a third group of devices, as illustrative, non-limiting examples. The table 230 also identifies, for each of the multiple groups, one or more STAs or one or more BSSs that are included in the group. For example, the strong group may include the third STA (STA1-3) 116, the fifth STA (STA2-2) 124, the seventh STA (STA3-2) 134, and the seventh STA (STA3-2) 134. As another example, the first group may include the first BSS 102 and the fourth BSS 108. As indicated by the table 230, the fourth BSS 108 may be included in the first group and the second group. Each station assigned to a group may be identified by a corresponding station identifier and each BSS (including multiple devices) assigned to a group may be identified by a corresponding BSS identifier.

A first graph that illustrates a first example of allocating a communication resource is depicted and generally designated 240. For example the communication resource may include a communication channel that has a corresponding communication channel bandwidth. In some implementations, the communication channel may be allocated among the multiple groups identified in the table 230. The first graph 240 illustrates an example of allocating the communication resource (e.g., the communication channel bandwidth) in the frequency domain. During a first time period, an entirety of the communication channel bandwidth may be allocated to the strong group. During a second period of time, the communication channel bandwidth may be allocated in the frequency domain among the first group, the second group, and the third group. For example, a first sub-band of the communication channel bandwidth may be allocated to the first group, a second sub-band of the communication channel bandwidth may be allocated to the second group, and a third sub-band of the communication channel bandwidth may be allocated to the third group. Each of the first sub-band, the second sub-band, and the third sub-band may be distinct sub-bands of the communication channel. In some implementations, the strong group may reuse the communication channel for Z % of a total time period that includes the first time period and the second time period, where Z is positive number. A value of Z may be proportional to a size of the strong group, such as a number of STAs included in the strong group as compared to a total number of STAs of the system 200. Accordingly, the second period of time may correspond to (100-Z)% of the total time period.

A second graph that illustrates a second example of allocating a communication resource is depicted and generally designated 250. For example the communication resource may include a communication channel that has a corresponding communication channel bandwidth. In some implementations, the communication channel may be allocated among the multiple groups of devices identified in the table 230. The second graph 250 illustrates an example of allocating the communication resource (e.g., the communication channel bandwidth) in the time domain. During a first time period, an entirety of the communication channel bandwidth may be allocated to the strong group. During a second period of time, an entirety of the communication channel bandwidth may be allocated to the first group. During a third period of time, an entirety of the communication channel bandwidth may be allocated to the second group. During a fourth period of time, an entirety of the communication channel bandwidth may be allocated to the third group. Each of the first period of time, the second period of time, the third period of time, and the fourth period of time may be non-overlapping periods of time. In some implementations, the strong group may reuse the communication channel for W % of a total time period that includes the first time period and the second time period, where W is positive number. A value of W may be proportional to a size of the strong group, such as a number of STAs included in the strong group as compared to a total number of STAs of the system 200. Accordingly, a time period of each of the second time period, the third time period, and the fourth time period may be equal to one third of (100-W)% of the total time period.

Referring to TABLE 1 (below), notations are described that may be used herein with reference to FIG. 3 or FIG. 4.

TABLE 1

| Notation | Description |
|---|---|
| APi | The AP of BSS i, where i is positive integer |
| STAi,j | The jth STA of BSS i, where j is a positive |
| | integer |
| STAn,m | The mth STA of BSS n, where n is a positive |
| | integer and m is a positive integer |
| Attn(APi, STAi, j) | The signal attenuation from APi to STAi,j |
| StrongSTAs(APi) | Strong STAs identified by APi |
| WeakSTA(APi) | The weakest STA identified by APi |
| G(k, APi) | APi is assigned to group k, where k is a positive |
| | integer |
| AttnStats(STAn, APi) | The statistical attenuation from STA(s) of BSS |
| | n to APi |

Referring to FIG. 3, an illustrative aspect of a method 300 of grouping basic service sets (BSSs) to allocate a downlink channel among the BSSs is shown. The BSSs may include multiple BSSs, such as the BSSs 102-108 of FIG. 1. The method 300 may be performed by an access point, such as the AP 110, 120, 130, 140 of FIG. 1, or another device, such as a device coupled to a system that includes multiple BSSs.

The method 300 may include obtaining topology information corresponding to a first BSS and a second BSS, at 302. The first BSS and the second BSS may be neighboring BSSs. The first BSS may include or correspond to a BSS i and the second BSS may include or correspond to a BSS i+1. In some implementations, the first BSS (BSS i) may receive topology information from one or more stations associated with an AP (APi) of the first BSS (BSS i). To illustrate, STAi,j may periodically report measured Attn(APi, STAi,j) and Attn(APn, STAi,j) to APi, for one or more BSSs where n !=i.

The method 300 may include identifying a first set of strong stations corresponding to the first BSS and identifying a second set of strong stations corresponding to the second BSS, at 304. For example, APi may determine a set of strong STAi,j (e.g., StrongSTAs(APi)) that each satisfy:

Attn(APn, STAi,j)>Attn(APi, STAi,j)+(first threshold) && Attn(APn, APi)>Attn(STAi,j, APi)+(second threshold),

for all n !=i, where && is a logical AND. The APi may also determine StrongSTAs(APn).

The method 300 may also include determining a weakest STA of the first BSS relative to one or more neighboring BSSs of the first BSS, at 306. For example, first BSS may determine a single weakest station of the first BSS relative to all neighboring BSSs of the first BSS. To illustrate, APi may determine a weakest STAi,j (e.g., WeakSTA(APi)) that has a smallest value of:

Attn(APn, STAi,j)−Attn(APi, STAi,j),

for all n !=i.

The method 300 may further include determining a weakest STA of the second BSS relative to one or more neighboring BSSs of the second BSS, at 308. For example, first BSS may determine a single weakest station of the first BSS relative to all neighboring BSSs of the first BSS.

The method 300 may include determining whether the first BSS and the second BSS are compatible, at 310. The first BSS and the second BSS may be determined to be compatible based on a first AP (APi) of the first BSS (BSS i), the weakest STA (weakSTA(APi)) of the first BSS (BSS i), a second AP (APi+1) of the second BSS, and the weakest STA (weakSTA(APi+1)) of the second BSS (BSS i+1). For example, compatibility between the first BSS and the second BSS may be determined based on compatibility of a first link from APi to weakSTA(APi) and a second link from APi+1 to weakSTA(APi+1). To illustrate, the first BSS and the second BSS may be compatible if:

Attn(APi+1, STAi,j)>Attn(APi, STAi,j)+(first threshold) && Attn(APi+1, APi)>Attn(STAi,j, APi)+(second threshold).

By determining compatibility using the first link that corresponds to the weakSTA(APi) and the second link that corresponds to the weakSTA(APi+1), if the first link and the second link are determined to be compatible, so too is each link of the first BSS (BSS i) compatible with each link of the second BSS (BSS i+1).

If the first BSS and the second BSS are determined to be compatible, the method 300 may assign the first BSS and the second BSS to the same group of devices, at 312. For example, the first BSS may have G(k,APi) and the second BSS may have G(k,APi+1). Alternatively, if the first BSS and the second BSS are determined to be incompatible, the method 300 may assign the first BSS and the second BSS to different groups of devices, at 314. For example, the first BSS may have G(k,APi) and the second BSS may have G(k+1,APi+1).

In some implementations, a weakest station may be determined for each BSS of the multiple BSSs. Additionally, compatibility may determine between each combination of two BSSs of the multiple BSSs to include as many compatible BSSs in each group. After each BSS is assigned to one or more groups of devices, a communication resource, such as a communication channel, may be allocated among the one or more groups. For example, the communication resource may be allocated in a frequency domain, in a time domain, or both.

Referring to FIG. 4, an illustrative aspect of a method 400 of grouping basic service sets (BSSs) used to allocate an uplink downlink channel among the BSSs is shown. The BSSs may include or correspond to the BSSs 102-108 of FIG. 1. The method 400 may be performed by an access point, such as the access point 110, 120, 130, 140 of FIG. 1, or another device, such as a device coupled to a system that includes multiple BSSs.

The method 400 may include obtaining topology information corresponding to a first BSS and a second BSS, at 402. The first BSS and the second BSS may be neighboring BSSs. The first BSS may include or correspond to a BSS i and the second BSS may include or correspond to a BSS i+1. In some implementations, the first BSS (BSS i) may receive topology information from one or more stations associated with an AP (APi) of the first BSS (BSS i). To illustrate, STAi,j may periodically report measured Attn(APi, STAi,j) and AttnStats(STAn, STAi,j) to APi, for one or more BSSs, where n !=i.

The method 400 may include identifying a first set of strong stations corresponding to the first BSS and identifying a second set of strong stations corresponding to the second BSS, at 404. For example, APi may determine a set of strong STAi,j (e.g., StrongSTAs(APi)) that each satisfy:

AttnStats(STAn,m, APi)>Attn(STAi,j, APi)+(first threshold) && AttnStats(STAn,m, STAi,j)>Attn(APi, STAi,j)+(second threshold),

for all n !=i. The APi may also determine StrongSTAs(APn).

The method 400 may also include, for each neighboring BSS of the first BSS, determining a corresponding weakest station (STA) of the first BSS relative to the neighboring BSS of the first BSS, at 406. For example, the APi may determine a first WeakSTA(APi) relative to the second BSS (BSSi+1) that neighbors the first BSS (BSSi). As another example, the APi may determine a second WeakSTA(APi) relative to a third BSS (BSSi+2) that neighbors the first BSS (BSSi). To illustrate, for each n !=i, the APi may determine a weakest STAi,j (e.g., WeakSTA(APi)) that has a smallest value of:

Attn(STAn,m, STAi,j)−Attn(STAi,j, APi).

In some implementations, the APi may determine a corresponding weakest STA for one or more BSS that the APi has BSS topology information for.

The method 400 may further include, for each neighboring BSS of the second BSS, determining a corresponding weakest STA of the second BSS relative to the neighboring BSS of the second BSS, at 408.

The method 400 may include determining whether the first BSS and the second BSS are compatible, at 410. The first BSS and the second BSS may be determined to be compatible based on a first AP (APi) of the first BSS (BSSi), a weakest STA of the first BSS relative to the second BSS, a second AP of the second BSS, and a weakest STA of the second BSS relative to the first BSS.

The first BSS and the second BSS may be determined to be compatible based on a first AP (APi) of the first BSS (BSS i), the weakest STA (weakSTA(APi)) of the first BSS (BSS i) relative to the second BSS (BSSi+1), a second AP (APi+1) of the second BSS (BSSi+1), and the weakest STA (weakSTA(APi+1)) of the second BSS (BSS i+1) relative to the first BSS (BSSi). For example, compatibility between the first BSS and the second BSS may be determined based on compatibility between of a first link from weakSTA(APi) (e.g., relative to the second BSS (BSSi+1)) to APi and a second link from weakSTA(APi+1) (e.g., relative to the first BSS (BSSi)) to APi+1. To illustrate, the first BSS and the second BSS may be compatible if:

AttnStats(STAi+1, APi)>Attn(weakSTA(APi), APi)+(first threshold) && AttnStats(STAi+1, weakSTA(APi))>Attn(APi, weakSTA(APi))+(second threshold).

By determining compatibility using the first link that corresponds to the weakSTA(APi) relative to the second BSS (BSSi+1) and using the second link that corresponds to the weakSTA(APi+1) relative to the first BSS (BSSi), if the first link and the second link are determined to be compatible, so too is each link of the first BSS (BSS i) compatible with each link of the second BSS (BSS i+1).

If the first BSS and the second BSS are determined to be compatible, the method 400 may assign the first BSS and the second BSS to the same group of devices, at 412. For example, the first BSS may have G(k,APi) and the second BSS may have G(k,APi+1). Alternatively, if the first BSS and the second BSS are determined to be incompatible, the method 400 may assign the first BSS and the second BSS to different groups of devices, at 414. For example, the first BSS may have G(k,APi) and the second BSS may have G(k+1,APi+1).

In some implementations, a weakest station may be determined for each BSS of the multiple BSSs. Additionally, compatibility may determine between each combination of two BSSs of the multiple BSSs to include as many compatible BSSs in each group. After each BSS is assigned to one or more groups of devices, a communication resource, such as a communication channel, may be allocated among the one or more groups. For example, the communication resource may be allocated in a frequency domain or in a time domain.

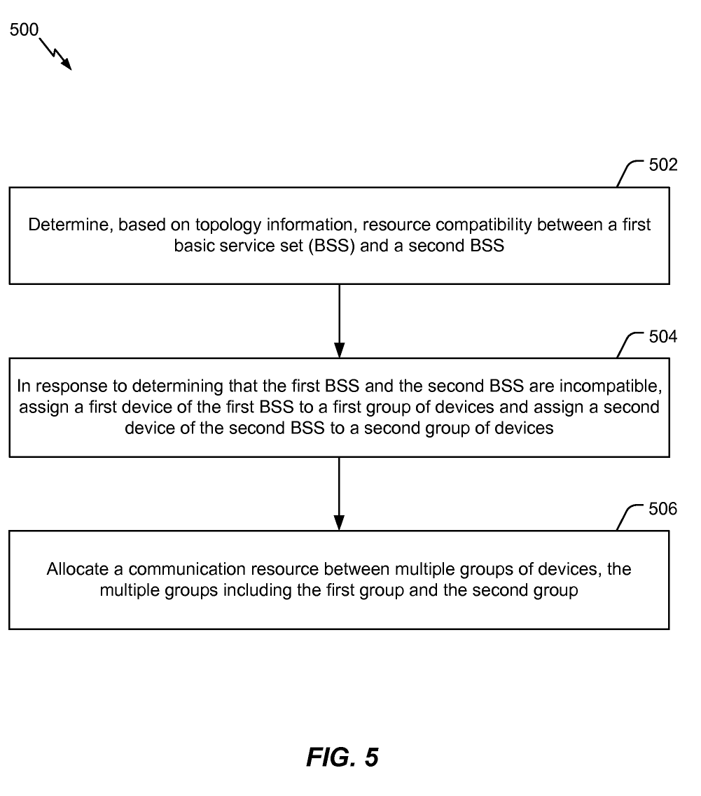

Referring to FIG. 5, an illustrative aspect of a method 500 of grouping basic service sets (BSSs) is shown. The BSSs may include or correspond to the BSSs 102-108 of FIG. 1. The method 500 may be performed by an access point, such as the access point 110, 120, 130, 140 of FIG. 1, or another device, such as a device coupled to a system that includes multiple BSSs.

The method 500 includes determining, based on topology information, resource compatibility between a first basic service set (BSS) and a second BSS, at 502. In some implementations, the first BSS and the second BSS are overlapping BSSs. The topology information may include positioning information, interference information, or a combination thereof. For example, the topology information may include or correspond to the station topology information 160, the AP topology information 180, or the BSS topology information 170 of FIG. 1. The resource compatibility may correspond to channel reuse capability. For example, the communication resource may include a communication channel, such as a communication channel having a corresponding bandwidth.

The method 500 further includes, in response to determining that the first BSS and the second BSS are incompatible, assigning a first device of the first BSS to a first group of devices and assigning a second device of the second BSS to a second group of devices, at 504. The method 500 also includes allocating a communication resource between multiple groups of devices, the multiple groups including the first group and the second group, at 506. The communication resource may be allocated between the multiple groups in a frequency domain or in a time domain.

In a particular implementation, the communication resource may be allocated in the frequency domain. For example, a first portion of the bandwidth of the communication resource (e.g., the communication channel) may be allocated to be used by the first group during a time period. A second portion of the bandwidth may be allocated to be used by the second group during the time period. The first portion may be distinct from the second portion. In another particular implementation, the communication resource may be allocated in the time domain. For example, the bandwidth may be allocated to be used by the first group during a first time period and may be allocated to be used by the second group during a second time period, where the first time period is distinct from the second time period.

In some implementations, determining the resource compatibility between the first BSS and the second BSS may include identifying a first data link, such as a communication path, between a first access point of the first BSS and a first station of the first BSS, and identifying a second data link between a second access point of the second BSS and a second station of the second BSS. Resource compatibility between two data links may be determined as described herein with reference to FIGS. 1, 3, or 4. For example, the method 500 may include determining whether the first data link can tolerate interference caused by the second data link, and determining whether the second data link can tolerate interference cause by the first data link. Additionally or alternatively, a first set of strong stations of the first BSS may be identified and assigned a third group of devices. A second set of strong stations of the second BSS may also be identified and assigned to the third group.

In some implementations, the method 500 may include identifying a first data link between a first access point of the first BSS and a first station of the first BSS. For each data link of the second BSS, the method 500 may include determining whether the first data link can tolerate interference caused by another data link, and identifying the first station as a strong station in response to determining that the first data link can tolerate interference caused by each data link corresponding to the second BSS.

In some implementations, the communication resource corresponds to a downlink channel. If the communication resource corresponds to the downlink channel, determining the resource compatibility between the first BSS and the second BSS may include identifying a first weakest station included in the first BSS with respect to one or more neighboring BSSs of the first BSS. Additionally, a second weakest station that is included in the second BSS may be identified with respect to one or more neighboring BSSs of the second BSS. The resource compatibility between the first BSS and the second BSS may be determined based on the first weakest station and the second weakest station, as described above with reference to FIG. 3. Additionally or alternatively, a third weakest station included in a third BSS may be identified with respect to one or more neighboring BSSs of the third BSS. Resource compatibility may be determined between the first BSS and the third BSS based on the first weakest station and the third weakest station, and between the second BSS and the third BSS based on the second weakest station and the third weakest station. In some implementations, a weakest station of the first BSS may be identified for each neighboring access point of a first access point of the first BSS.

In some implementations, the communication resource corresponds to an uplink channel. If the communication resource corresponds to the uplink channel, determining the resource compatibility between the first BSS and the second BSS may include identifying a first weakest station included in the first BSS with respect to the second BSS, and identifying a second weakest station included in the second BSS with respect to the first BSS. The resource compatibility between the first BSS and the second BSS may be determined based on the first weakest station and the second weakest station, as described above with reference to FIG. 4. Additionally or alternatively, a third weakest station included in the first BSS may be identified with respect to a third BSS and a fourth weakest station included in the third BSS may be identified with respect to the first BSS. Resource capability between the first BSS and the third BSS may be determined based on the third weakest station and the fourth weakest station. In some implementations, when the communication resource corresponds to an uplink channel, attenuation from one or more stations of the second BSS to a first access point of the first BSS may be determined using a statistical method.

In some implementations, the method 500 may include determining resource compatibility between a third BSS and the first BSS and determining resource compatibility between the third BSS and the second BSS. In response to determining the third BSS is incompatible with the first BSS and is incompatible with the second BSS, a third device of the third BSS may be assigned to a third group of devices. Additionally or alternatively, resource compatibility may be determined between a fourth BSS and the first BSS. In response to determining the fourth BSS is compatible with the first BSS, a fourth device of the fourth BSS may be assigned to the first group. Additionally or alternatively, resource compatibility may be determined between the fourth BSS and the second BSS. In response to determining the fourth BSS is compatible with the second BSS, the fourth device of the fourth BSS may be assigned to the second group.

In other implementations, for each station included in the first BSS, a first attenuation may be determined between a first access point of the first BSS and the station. For each neighboring access point of the first access point, a corresponding second attenuation may be determined between the neighboring access point and the station, and a difference value may be between the corresponding second attenuation of the neighboring access point and the first attenuation. After one or more difference values are determined, a smallest difference value may be identified from the one or more determined difference values, and a particular station of the first BSS that corresponds to the smallest difference value may be selected as a weakest station of the first BSS. For example, referring to the first AP 110 of FIG. 1, the first AP 110 may determine the one or more difference values and may select a particular station that corresponds to the smallest difference value as the weakest station of the first BSS.

The method 500 enables communication resource allocation among multiple groups of devices to improve system throughput and fairness of a system that includes multiple BSSs, such a densely deployed system that includes multiple OBSSs. Devices of the system may include or may use WiFi hardware and media access control (MAC) protocols, such as a carrier sense multiple access (CSMA) protocol. The communication resource allocation among the multiple groups may be implemented to alleviate the problems of reduced fairness and reduced system capacity that exist in systems that use a MAC protocol.

The process shown in the method 300 of FIG. 3, the method 400 of FIG. 4, and/or the method 500 of FIG. 5 may be controlled by a processing unit such as a central processing unit (CPU), a controller, a field-programmable gate array (FPGA) device, an application-specific integrated circuit (ASIC), another hardware device, firmware device, or any combination thereof. As an example, the method 300 of FIG. 3, the method 400 of FIG. 4, and/or the method 500 of FIG. 5 can be performed by one or more processors that execute instructions to group BSSs or to allocate a communication resource among multiple BSSs.

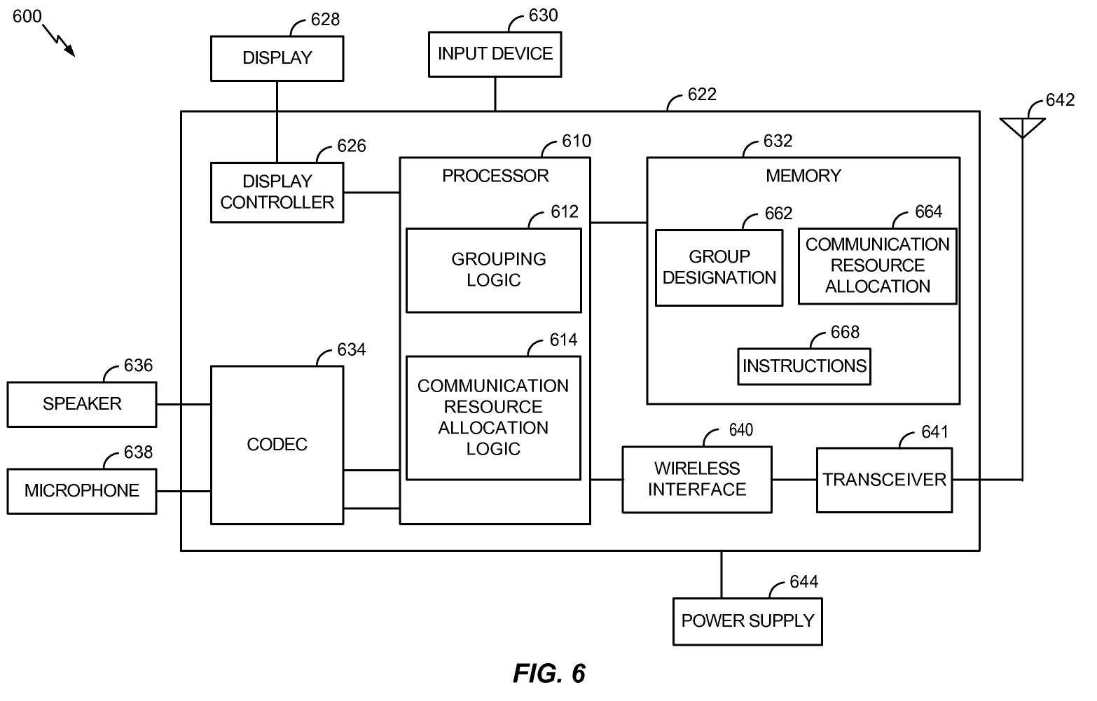

Referring to FIG. 6, a particular illustrative aspect of an electronic device, such as a wireless communication device, is depicted and generally designated 600. The electronic device 600 includes a processor 610, such as a digital signal processor, coupled to a memory 632. The electronic device 600, or components thereof, may correspond to the APs 110, 120, 130, 140 or the stations 112, 114, 116, 122, 124, 132, 134, 142, 144 of FIG. 1, or components thereof.

Memory 632, such as a non-transitory computer readable medium, may include a group designation 662, a communication resource allocation 664, and instructions 668. The instructions may be executable by the processor 610. The group designation 662 may indicate a particular group of devices of multiple groups of devices to which the electronic device 600 belongs. In some implementations, the group designation 662 may indicate that the electronic device 600 belongs to more than one group of the multiple groups of devices. The communication resource allocation 664 may indicate an allocation of a communication resource among the multiple groups. For example, the communication resource allocation 664 may indicate whether the communication resource is allocated in a frequency domain or a time domain. Additionally or alternative, the communication resource allocation 664 may indicate when each group of the multiple groups may access the communication resource.

The processor 610 may include grouping logic 612 and communication resource allocation logic 614. The grouping logic 612 may be configured to group multiple BSSs, multiple stations, multiple access points, or a combination thereof, into multiple groups of devices. For example, the grouping logic 612 may be configured to perform at least a portion of the method 300 of FIG. 3, the method 400 of FIG. 4, and/or the method 500 of FIG. 5. The communication resource allocation logic 614 may be configured to allocate access to the communication resource among the multiple groups. For example, the communication resource allocation logic 614 may be configured to perform at least a portion of the method 500 of FIG. 5.

The processor 610 may be configured to execute software (e.g., a program of one or more instructions 668) stored in the memory 632. For example, the processor 610 may be configured to operate in accordance with the method 300 of FIG. 3, the method 400 of FIG. 4, the method 500 of FIG. 5, or a combination thereof. To illustrate, the processor 610 may be configured to execute the instructions 668 that cause the processor 610 to determine, based on topology information, resource compatibility between a first basic service set (BSS) and a second BSS. The processor 610 may also execute the instructions 668 to cause the processor to, in response to determining the first BSS and the second BSS are incompatible, assign a first device of the first BSS to a first group of devices and assigning a second device of the second BSS to a second group of devices. The processor 610 may further execute the instructions 668 to cause the processor to allocate a communication resource between multiple groups of devices, the multiple groups including the first group and the second group.

FIG. 6 also shows a display controller 626 that is coupled to the processor 610 and to a display 628. A coder/decoder (CODEC) 634 can also be coupled to the processor 610. A speaker 636 and a microphone 638 can be coupled to the CODEC 634.

FIG. 6 also indicates that a wireless interface 640 can be coupled to the processor 610 and to an antenna 642. For example, the wireless interface 640 may be coupled to the antenna 642 via a transceiver 641. The transceiver 641 may include a transmitter, a receiver, or both. The transceiver 641 may be configured to transmit one or more messages generated by the electronic device 600 and to receive one or more messages transmitted to the electronic device 600 by other devices, such as other stations and/or other access points. In some implementations, if the transceiver 641 includes the receiver, the receiver may correspond to a first group of devices as indicated by the group designation 662. Accordingly, the receiver may be configured to receive data via at least a portion of the communication resource during a time period that corresponds to the first group. The portion of the communication resource, the time period, or a combination thereof may be indicated by the communication resource allocation 664. Additionally or alternative, if the transceiver 641 includes the transmitter, the transmitter may correspond to the first group as indicated by the group designation 662. Accordingly, the transmitter may be configured to transmit data via at least the portion of the communication resource during the time period that corresponds to the first group.

In some implementations, the processor 610, the display controller 626, the memory 632, the CODEC 634, the wireless interface 640, and the transceiver 641 are included in a system-in-package or system-on-chip device 622. In a particular implementation, an input device 630 and a power supply 644 are coupled to the system-on-chip device 622. Moreover, in another particular implementation, as illustrated in FIG. 6, the display 628, the input device 630, the speaker 636, the microphone 638, the antenna 642, and the power supply 644 are external to the system-on-chip device 622. However, each of the display 628, the input device 630, the speaker 636, the microphone 638, the antenna 642, and the power supply 644 can be coupled to a component of the system-on-chip device 622, such as an interface or a controller.

In conjunction with one or more of the described aspects of FIGS. 1-6, an apparatus includes means for assigning a first device of a first basic service set (BSS) to a first group of devices of multiple groups of devices and assigning a second device of a second BSS to a second group of devices of the multiple groups of devices in response to determining, based on topology information corresponding to the first BSS, that the first BSS and the second BSS are incompatible. For example, the means for assigning the first device of the first BSS and assigning the second device of the second BSS may include or correspond to the grouping logic 612, the processor 610 programmed to execute the instructions 668 of FIG. 6, one or more other structures, devices, circuits, modules, or instructions to assign the first device of the first BSS to the first group and to assign the second device of the second BSS to the second group, or any combination thereof.

The first apparatus also includes means for accessing a communication resource based on an assigned group of devices of the multiple groups of devices. For example, the means for accessing may include or correspond to the wireless interface 640, the transceiver 641, the antenna 642, the processor 610 programmed to execute the instructions 668 of FIG. 6, one or more other structures, devices, circuits, modules, or instructions to access the communication resource, or any combination thereof.

One or more of the disclosed aspects may be implemented in a system or an apparatus, such as the electronic device 600, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the electronic device 600 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, any other device that includes a processor or that stores or retrieves data or computer instructions, or a combination thereof. As another illustrative, non-limiting example, the system or the apparatus may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

Although one or more of FIGS. 1-6 may illustrate systems, apparatuses, and/or methods according to the teachings of the disclosure, the disclosure is not limited to these illustrated systems, apparatuses, and/or methods. One or more functions or components of any of FIGS. 1-6 as illustrated or described herein may be combined with one or more other portions of another function or component of FIGS. 1-6. Accordingly, no single example described herein should be construed as limiting and examples of the disclosure may be suitably combined without departing from the teachings of the disclosure.

Those of skill in the art would further appreciate that the various illustrative logical blocks, configurations, modules, circuits, and algorithm steps described in connection with the aspects disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the examples disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal In the alternative, the processor and the storage medium may reside as discrete components in a computing device or user terminal

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. An apparatus comprising:
a receiver configured to receive topology information corresponding to a first basic service set (BSS); and
a processor configured to determine, based on the topology information, resource compatibility between the first BSS and a second BSS and, in response to determining the first BSS and the second BSS are incompatible, to assign a first device of the first BSS to a first group of devices and to assign a second device of the second BSS to a second group of devices, wherein the processor is further configured to allocate a communication resource between multiple groups of devices, the multiple groups including the first group and the second group.

2. The apparatus of claim 1, wherein, to determine the resource compatibility, the processor is configured to determine whether to enable the first device of the first BSS and the second device of the second BSS to concurrently use the communication resource.

3. The apparatus of claim 1, wherein the communication resource comprises a communication channel.

4. The apparatus of claim 1, wherein the communication resource is allocated between the multiple groups in a frequency domain, in a time domain, or both.

5. The apparatus of claim 1, wherein the topology information comprises positioning information, interference information, or a combination thereof.

6. The apparatus of claim 1, wherein the first BSS and the second BSS are overlapping BSSs.

7. The apparatus of claim 1, wherein the receiver is included in a device of the first group of the multiple groups, wherein the communication resource includes a frequency band, and wherein the receiver is configured to receive data via a sub-band of the frequency band during a time period that corresponds to the first group.

8. The apparatus of claim 1, further comprising a transmitter, wherein the transmitter is included in a device of the first group of the multiple groups, wherein the communication resource includes a frequency band, and wherein the transmitter is configured to transmit data via a sub-band of the frequency band during a time period that corresponds to the first group.

9. A method for resource allocation, the method comprising:
determining, based on topology information, resource compatibility between a first basic service set (BSS) and a second BSS;
in response to determining the first BSS and the second BSS are incompatible, assigning a first device of the first BSS to a first group of devices and assigning a second device the second BSS to a second group of devices; and
allocating a communication resource between multiple groups of devices, the multiple groups including the first group and the second group.

10. The method of claim 9, further comprising:
identifying a first data link between a first access point of the first BSS and the first device of the first BSS; and
assigning the first device to a third group of devices in response to determining that interference caused by each data link of the second BSS and received at the first device is less than a threshold.

11. The method of claim 9, further comprising:
determining a first set of strong stations of the first BSS; and
assigning each station of the first set of strong stations to a third group of devices.

12. The method of claim 11, further comprising:
determining a second set of strong stations of the second BSS; and
assigning each station the second set of strong stations to the third group.

13. The method of claim 9, wherein determining the resource compatibility between the first BSS and the second BSS comprises:
identifying a first data link between a first access point of the first BSS and the first device of the first BSS; and
identifying a second data link between a second access point of the second BSS and the second device of the second BSS.

14. The method of claim 13, wherein determining the resource compatibility between the first BSS and the second BSS further comprises:
determining whether first interference caused by the first data link and received at the second device is less than a first threshold; and
determining whether second interference caused by the second data link and received at the first device is less than a second threshold.

15. The method of claim 9, wherein the communication resource comprises a downlink channel, and wherein determining the resource compatibility between the first BSS and the second BSS further comprises:
identifying the first device, wherein the first device corresponds to a weakest station that is included in the first BSS with respect to one or more neighboring BSSs of the first BSS; and
identifying the second device, wherein the second device corresponds to a weakest station that is included in the second BSS with respect to one or more neighboring BSSs of the second BSS, wherein the resource compatibility between the first BSS and the second BSS is determined based on the first device and the second device.

16. The method of claim 15, further comprising:
identifying a third device, wherein the third device corresponds to a weakest station that is included in a third BSS with respect to one or more neighboring BSSs of the third BSS;
determining resource compatibility between the first BSS and the third BSS based on the first device and the third device; and
determining resource compatibility between the second BSS and the third BSS based on the second device and the third device.

17. The method of claim 9, wherein the communication resource comprises an uplink channel, and wherein determining the resource compatibility between the first BSS and the second BSS comprises:
identifying the first device, wherein the first device corresponds to a weakest station that is included in the first BSS with respect to the second BSS; and
identifying the second device, wherein the second device corresponds to a weakest station that is included in the second BSS with respect to the first BSS, wherein the resource compatibility between the first BSS and the second BSS is determined based on the first device and the second device.

18. The method of claim 17, further comprising:
identifying a third device, wherein the third device corresponds to a weakest station that is included in the first BSS with respect to a third BSS;
identifying a fourth device, wherein the fourth device corresponds to a weakest station that is included in the third BSS with respect to the first BSS; and
determining resource capability between the first BSS and the third BSS based on the third device and the fourth device.

19. The method of claim 9, further comprising determining attenuation from one or more stations of the second BSS to a first access point of the first BSS using a statistical method, and wherein the communication resource comprises an uplink channel.

20. A non-transitory computer readable medium comprising instructions that, when executed by a processor, cause the processor to:
determine, based on topology information, resource compatibility between a first basic service set (BSS) and a second BSS;
in response to determining the first BSS and the second BSS are incompatible, assign a first device the first BSS to a first group of devices and assigning a second device the second BSS to a second group of devices; and
allocate a communication resource between multiple groups of devices, the multiple groups including the first group and the second group.

21. The non-transitory computer readable medium of claim 20, wherein allocating the communication resource comprises allocating time periods to the first group and the second group, allocating one or more sub-bands of a frequency band to the first group and the second group, or a combination thereof.

22. The non-transitory computer readable medium of claim 20, wherein the instructions, when executed by the processor, further cause the processor to:
determine resource compatibility between a third BSS and the first BSS; and
determine resource compatibility between the third BSS and the second BSS.

23. The non-transitory computer readable medium of claim 22, wherein the instructions, when executed by the processor, further cause the processor to, in response to determining the third BSS is incompatible with the first BSS and is incompatible with the second BSS, assign a third device of the third BSS to a third group of devices.

24. The non-transitory computer readable medium of claim 20, wherein the instructions, when executed by the processor, further cause the processor to:
determine resource compatibility between a fourth BSS and the first BSS; and
in response to determining the fourth BSS is compatible with the first BSS, assign a fourth device of the fourth BSS to the first group.

25. The non-transitory computer readable medium of claim 24, wherein the instructions, when executed by the processor, further cause the processor to:
determine resource compatibility between the fourth BSS and the second BSS; and
in response to determining the fourth BSS is compatible with the second BSS, assign the fourth device of the fourth BSS to the second group.

26. The non-transitory computer readable medium of claim 20, wherein the instructions, when executed by the processor, further cause the processor to:
for each station included in the first BSS:
determine a first attenuation between a first access point of the first BSS and the station; and
for each neighboring access point of the first access point:
determine a corresponding second attenuation between the neighboring access point and the station; and
determine a difference value between the corresponding second attenuation of the neighboring access point and the first attenuation;
determine a smallest difference value of the determined difference values; and
select a particular station of the first BSS that corresponds to the smallest difference value as a weakest station of the first BSS.

27. The non-transitory computer readable medium of claim 20, wherein the instructions, when executed by the processor, further cause the processor to, for each neighboring access point of a first access point of the first BSS, identify a corresponding weakest station of the first BSS.

28. An apparatus comprising:
means for assigning a first device a first basic service set (BSS) to a first group of devices of multiple groups of devices and assigning a second device of a second BSS to a second group of devices of the multiple groups of devices in response to determining, based on topology information corresponding to the first BSS, that the first BSS and the second BSS are incompatible; and
means for accessing a communication resource based on an assigned group of devices of the multiple groups.

29. The apparatus of claim 28, wherein the communication resource comprises a communication channel.

30. The apparatus of claim 29, wherein the communication channel includes a frequency band, wherein a first sub-band of the frequency band is allocated to be used by the first group during a time period, wherein a second sub-band of the frequency band is allocated to be used by the second group during the time period, and wherein the first sub-band is distinct from the second sub-band.
